(19) United States
(12) Patent Application Publication
(10) Pub. No.: US 2004/0169069 A1
(43) Pub. Date: Sep. 2, 2004

(54) Punching machine

(76) Inventor: Giogio Ostini, Grono (CH)

Correspondence Address: NIXON & VANDERHYE, PC, 1100 N GLEBE ROAD, 8TH FLOOR, ARLINGTON, VA, 22201-4714, US

(21) Appl. No.: 10/756,760

(22) Filed: Jan. 14, 2004

(30) Foreign Application Priority Data
Jan. 14, 2003 (GB) 0300817.4

(51) Int. Cl. B26F 1/04

(52) U.S. Cl. 234/109; 83/549; 83/687

(57) ABSTRACT

The punching machine comprises a base frame which defines an upper horizontal work table for working metal sheets and bars, an operating turret positioned above said work table and housing a punching ram, a first support member for at least one male punch holder driven rotationally by a respective first motor assembly and supported on said turret in vertical alignment below said punching ram, a second support member for a female die holder inserted in said work table in vertical alignment with said first support member and driven rotationally by a respective second motor assembly synchronised with said first motor assembly, at least one element for selection and contact with a male punch interposed between said ram and said male punch holder driven rotationally by a respective third motor assembly; said male punch holder and female die holder can be driven by respective drive arrangements with synchronous rotational movement around a common vertical axis relative to said first support member and said second support member.

### BACKGROUND OF THE INVENTION

The present invention relates to a punching machine.

Conventional punching machines for the machining of metal sheets and bars essentially comprise a base provided on the upper face thereof with a supporting table on which metal sheets or bars are moved during machining, and an operating turret inside which is mounted and supported a hydraulic cylinder which acts as a ram.

In the turret, positioned above the work table with a predetermined useful clearance to allow metal sheets and bars to pass through, there also is housed, below the ram, a support for one or more punches which are used from time to time to perform the various types of machining operations. Alignment with the ram is achieved by means of rotation of a general support in which the punch or punches are housed.

Correspondingly, on the vertical axis of the support for the punches, there is inserted in the supporting table a rotational support for female dies which must be aligned vertically with the aforesaid punches.

In the most modem versions of these punching machines, both the aforesaid supports may in turn house various kinds of cylindrical magazines, known in the trade as “multitools”. They are mounted in said supports in a rotationally fixed manner. Each holds respectively a given number of circularly distributed punches and an equal number of female dies, so that when the type of machining operation is changed, it is not necessary, each time, to interrupt the machining process in order to replace the punch and the corresponding female die.

Above the aforesaid male punch magazines, positioned between the punch magazines and the ram with a suitable clearance, there is provided a rotating selector element equipped with a downwardly projecting tooth, in practice a kind of hammer, for contact with the heads of the punches. It is positioned from time to time on one of the punches to select it from the others. The ram stroke will then cause the selected punch, and only the selected punch, to operate by means of the aforesaid tooth.

The general operation of these punching machines is controlled electronically by specific presettable programs. According to requirements, the programs automatically select suitable punches for each type of requisite machining operation and aligns them axially with the corresponding dies.

Rotation of the aforesaid punch and die supports, and of the selector element, is achieved by means of dedicated motors equipped with position detection indexes.

Conventional punching machines, therefore, are provided with a turret and a supporting table that incorporate respective first supports for punches and dies, which can be driven with synchronous rotation, and a selector which rotates in order to choose the punch to be used from time to time.

### SUMMARY OF THE INVENTION

This prior art is open to further improvement to give conventional punching machines a further possibility of movement of the punches and dies so as to increase their performance and refine their operating capabilities.

An objective of the present invention is to achieve the aforesaid refinement by developing an improved punching machine that is able to perform increasingly detailed and precise machining operations.

The present invention provides an improved punching machine as defined in claim 1, comprising a base frame which defines an upper horizontal table for working metal sheets and bars, an operating turret positioned above said work table and housing a punching ram, a first support member for at least one male punch holder driven rotationally by a respective first motor assembly and supported on said turret in vertical alignment below said punching ram, a second support member for a female die holder inserted in said work table in vertical alignment with said first support member and driven rotationally by a respective second motor assembly synchronised with said first motor assembly, and at least one element for selection and contact with said male punch interposed between said ram and said male punch holder driven rotationally by a respective third motor assembly, wherein said male punch holder and female die holder can be driven by respective drive arrangement with synchronous rotational movement around a common vertical axis relative to said first support member and said second support member.

### BRIEF DESCRIPTION OF THE DRAWINGS

Further characteristics and advantages of the invention will be more evident from the detailed description of a preferred but not exclusive embodiment of an improved punching machine illustrated by way of non-limiting example in the drawings, in which:

FIG. 1 is a schematic side view of the work zone of an improved punching machine according to the present invention;

FIG. 2 is a detailed schematic side view of the operating turret of the improved punching machine illustrated in FIG. 1;

FIG. 3 is a detailed schematic side view of the work table of the improved punching machine illustrated in FIG. 1;

FIG. 4 is a schematic top view of a first male punch-holder support member; and

FIG. 5 is a schematic top view of a second female die holder support member.

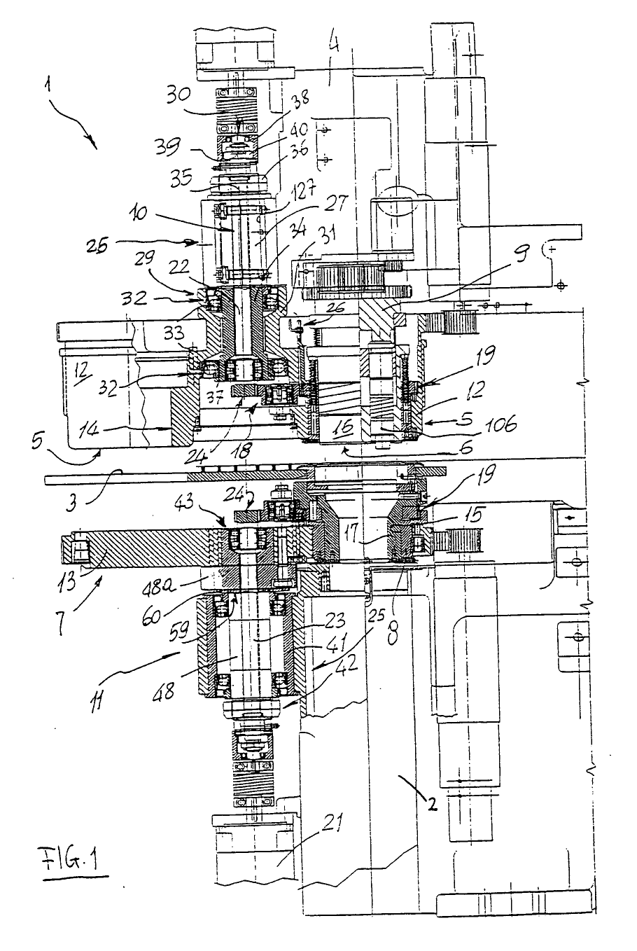

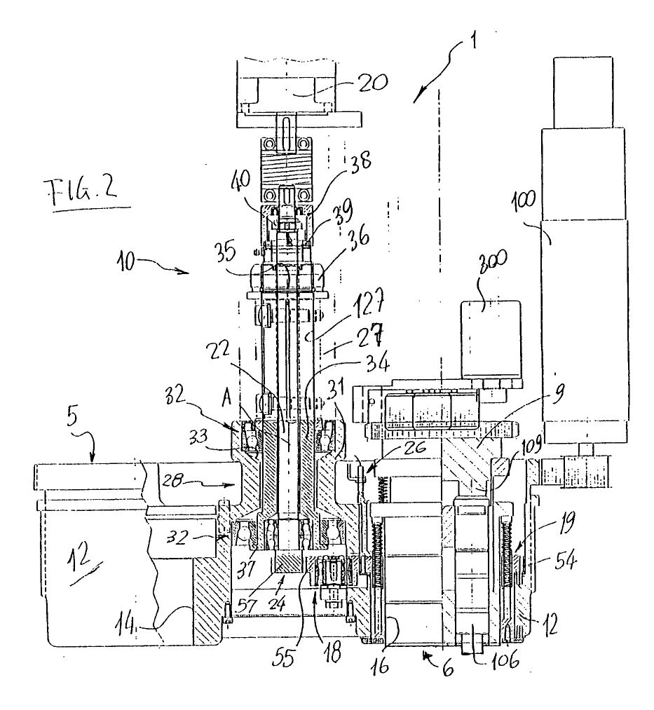

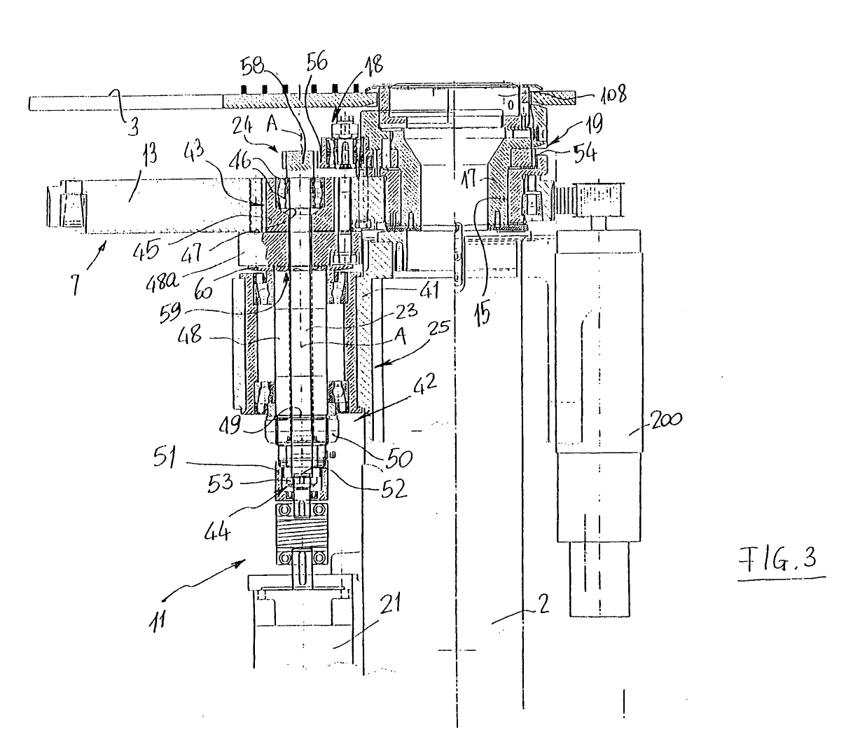

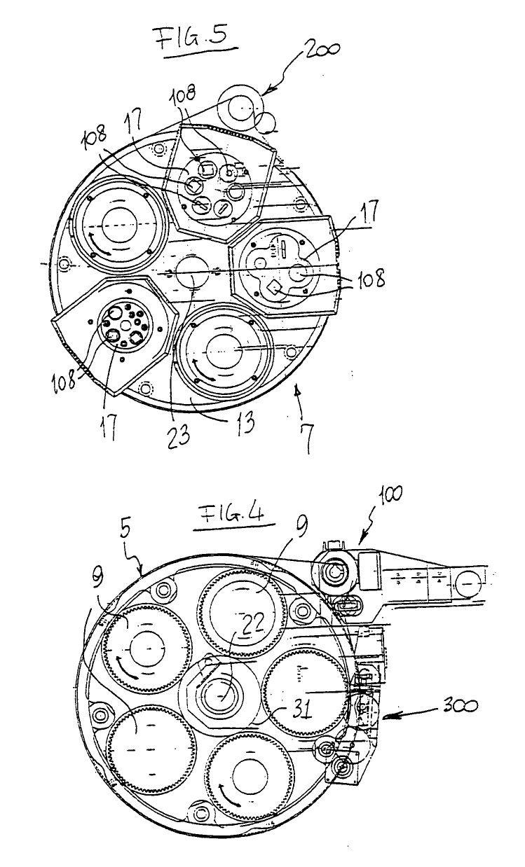

### DETAILED DESCRIPTION

With particular reference to the figures, reference sign 1 refers to an improved punching machine, which comprises a base frame 2 defining an upper horizontal table 3 for supporting metal sheets and bars undergoing machining operations.

Above table 3, the base frame 2 supports an operating turret 4 inside which are housed the active punching components, namely a ram (not illustrated as it is familiar to industry technicians), a first support member 5 for at least one male punch holder 6, which member 5 is rotationally supported on the operating turret 4 in vertical alignment below said ram and is driven by a first motor assembly 100.

In the base frame 2, or more precisely in the supporting table 3, there is inserted a second support member 7, which in turn supports a female die holder 8. The second support member 7 is vertically aligned with the first support member 5 and is also rotationally driven by a second respective motor assembly 200.

Between said second support member 7 and the ram, there is additionally provided, in the operating turret 4, an element 9, normally of circular shape and provided at the bottom with a tooth 109. The element 9 is capable of selecting at least one male punch 106 and pressing on the head thereof with the tooth 109. The element 9 is also rotationally driven by a respective third motor assembly 300.

According to the present invention, both the male punch holder 6 and the female die holder 8 can be driven by respective drive arrangements 10 and 11 in synchronous rotational movement around a common vertical axis marked as dashed line “A”, both with respect to the first support member 5 and the second support member 7.

Both the first support member 5 and the second support member 7 consist of cylindrical elements 12 and 13 with a number of housings 14 and 15 which can hold a number of male punch holders 6 and at the same time an equal number of female die holders 8.

In the preferred embodiment, both the male punch holder 6 and the female die holder 8 consist of cylindrical magazines, indicated respectively by 16 and 17, inside which can be housed, respectively, a pre-established number of male punches 106 and a corresponding number of female dies 108 which are vertically alignable with the respective male punches 106.

Both the first support member 5 and the second support member 7 are provided axially with a number of hollow housings 14 and 15 capable of holding, in a rotationally free fashion, the cylindrical magazines 16 and 17 for male punches 106 and female dies 108, respectively.

A device 18 for the transmission of rotational movement is provided between the male punch holders 6, the female die holders 8 and the respective rotational drive arrangements 10 and 11.

Both the male punch holders 6 and the female die holders 8 are provided perimetrically with a device 19 for mechanical coupling with their respective rotational drive arrangements 10 and 11 and, where envisaged, with the device 18 for transmission of rotational movement.

The rotational drive arrangements 10 and 11 for the cylindrical magazines 16 and 17 comprise respective motor/gear motor assemblies 20 and 21 fixed respectively to the operating turret 4 and the base frame 2. They are mutually synchronised. From each motor assembly 20 and 21 there project respectively a first and a second drive shaft, indicated by reference signs 22 and 23. On the opposing free ends of the drive shafts are born, either directly integrated or engaged therewith, gear member 24, engageable with the mechanical coupling device 19 or, where present, with the interposed rotational movement transmission means 18. A support and guide arrangement 25 is also provided for the aforesaid first and second drive shafts 22 and 23.

According to the invention, the drive shafts are supported vertically, mutually coaxially and with their respective free ends concurrent. Furthermore, the motor assemblies 20 and 21 are controlled by a device 26 for angular indexing of rotation, consisting for example of zero-point sensors.

The support and guide arrangement 25 for the first drive shaft 22 comprises an abutment 27 projecting from the turret 4 of the punching machine 1, which abutment contains an axial cavity. The abutment 27 can accommodate the first drive shaft 22 in a coaxially traversing manner, with the interposition of an anti-friction member which is not illustrated because it would already be familiar to a person skilled in the art.

The aforesaid arrangement 25 further comprises a device 28 for axial retention of the first drive shaft 22 inside the abutment 27 and a device 29 for the rotationally free passage of the lower end of the shaft 22 through the rotating support member 5 of the male punch holder or holders 6.

Between the first drive shaft 22 and the support and guide arrangement 25, there is provided a device 30 for control of the axial clearance of the first drive shaft 22.

The device 29 for the rotationally free passage of the lower end of the shaft 22 through the rotating support member 5 comprises a through opening 31 formed centrally in said cylindrical element 12 with a number of housings and an anti-friction member 32 interposed between said lower end of the first drive shaft 22 and the opening 31, located in corresponding housings 33 formed therein.

The device 28 for axial retention of the first drive shaft 22 in said abutment 27 comprises a rotationally fixed cylindrical liner 34 inside which the said first drive shaft 22 can be accommodated in a rotationally free manner and which is interposed between this and the internal cavity of the abutment 27, indicated as 127, and between this and the through opening 31.

On the cylindrical liner 34 there is formed, upstream of the abutment 27, a thread 35 onto which there can be screwed a first ring nut 36 which normally rests against the abutment itself and is fitted coaxially onto the liner 34 and is screwable onto the thread 35 in such a way that the tightening or loosening of said ring nut 36, resting in contact with the abutment 27, determines axial movements of the liner 34.

At the opposite end of the liner 34 there is formed a radially projecting lower edge 37 capable of remaining stationary against the anti-friction member 32 and of axially retaining the liner inside the opening 31 when the first ring nut 36 is tightened.

The device 30 for control of the axial clearance of the first drive shaft 22 comprises a box-shaped support 38 which is mounted integrally on the head of the liner 34 and is vertically traversable by the upper end of the first drive shaft 22, a second perimetral thread 39 formed on the latter substantially in the position of said box-like support 38 and a second ring nut 40 which can be retained in the box-like support 38 and can be screwed onto the aforesaid second thread 39. Tightening or loosening the second ring nut 40 again determines axial movement of the first drive shaft 22 relative to the liner 34.

The support and guide arrangement 25 for said second drive shaft 23 comprises a coupling flange 41 which projects from the base frame 2 of the punching machine 1 and which is provided with an axial cavity. The second drive shaft 23 can be accommodated in a coaxial traversing manner in said coupling flange, a dedicated axial retention device 42 being provided for the axial retention of said drive shaft inside the flange 41.

Likewise the second drive shaft 23 is provided with a device 43 for the rotationally free passage of the upper end of said drive shaft through the second support member 7 for the cylindrical magazine(s) 17.

Between the second drive shaft 23 and the support and guide arrangement 25 thereof, there is provided a device 44 for control of the axial clearance of the second drive shaft 23.

The device 43 for the rotationally free passage of the upper end of said drive shaft through the second support member 7 comprises a cylindrical body 45, provided with an axial cavity and centrally engaged with the same cylindrical element 13 with a number of housings, an anti-friction member 46 interposed between the upper end of the second drive shaft 23 and the aforesaid cylindrical body 45, located in respective housings 47 formed therein.

The device 42 for axial retention of the second drive shaft 23 in the coupling flange 41 comprises a second rotationally fixed cylindrical liner 48 equipped with an enlarged head 48a, inside which the aforesaid second drive shaft 23 can be housed in a rotationally free manner and which is interposed between this and the internal cavity of the coupling flange 41 and between this and the cylindrical body 45. On the aforesaid second cylindrical liner 48 there is peripherically formed a third thread 49 immediately downstream of the coupling flange 41. Onto this can be screwed a third ring nut 50 which normally rests against the coupling flange 41 and which is fitted coaxially onto the second liner 48. The tightening or loosening of the third ring nut 50 determines the axial movement of the second liner 48, pressing against the coupling flange 41.

The device 44 for controlling the axial clearance of the second drive shaft 23 comprises a second box-shaped support 51, which is integrally mounted on the base of the second liner 48 and which is vertically traversable by the lower end of the second drive shaft 23, a fourth perimetral thread 52 formed on the second drive shaft 23 substantially in the position of the second box-shaped support 51 and a fourth ring nut 53 that can be retained in the latter and is capable of being screwed onto the fourth thread 52 to move the second drive shaft 23 axially with respect to the coupling flange 41.

In the preferred embodiment of the punching machine 1, the rotational movement transmission device 19 consists of ring gears 54 which enclose the cylindrical magazines 16 and 17 in a perimetrically integral manner and which are engageable with the gear member 24.

The rotational movement transmission device 18 consists of respective perimetrically toothed idle rollers 55 and 56 which are interposed between the gear member 24 and the ring gears 54.

Finally, the gear member 24 consists of corresponding sprockets 57 and 58 which are engaged in a rotationally fixed manner to the concurrent respective ends of the first and second drive shafts 22 and 23.

It should also be noted that an elastic shock-absorbing arrangement 59 is interposed between the coupling flange 41 and the cylindrical element 13, consisting in this case of at least one Belleville spring washer, or a group of Belleville spring washers, indicated by reference sign 60.

The operation of the improved punching machine 1 according to the invention is as follows:

The first support member 5 is normally equipped with a series of male punch holders 6 inside which are inserted corresponding cylindrical magazines 16, each of which can carry one or more male punches 106.

Correspondingly, the second support member 7 is equipped with an equivalent series of female die holders 8 inside which are inserted corresponding cylindrical magazines 17, each of which can carry a total number of female dies 108 equal to that of the male punches 106 of the vertically aligned cylindrical magazine 16.

The first support member 5 and the second support member 7 are usually driven with synchronous rotation by the respective motor assemblies 100 and 200 in steps whose angular amplitude is controlled by the indexing device in such a way as to move the magazines 16 and 17, which have been selected for a given type of machining operation on a metal sheet or bar placed on the supporting table 3, into position below the ram.

After reaching this first position, according to the invention the cylindrical magazines 16 and 17 can be rotated inside their respective housings, around their coincident vertical axes, in such a way as to move a given punch 106 and the corresponding female die 108, selected out of those carried by each of them, to a predetermined position for machining on the metal sheet.

The rotation of the aforesaid cylindrical magazines 16 and 17 is also controlled by angular indexing device (for example, zero-point sensors), indicated by the number 26 in the figures; the synchronous rotation of the cylindrical magazines 16 and 17 is achieved by way of the respective motor assemblies 20 and 21, which act on the ring gears 54 with which the aforesaid magazines 16 and 17 are perimetrically provided by way of the drive shafts 22 and 23, the sprockets 57 and 58 and the idle pulleys 55 and 56.

When the selected magazines 16 and 17 have reached the position predetermined by the electronic logic governing the punching machine 1 according to a preset program, the selector element 9 is finally activated, which likewise rotates above the cylindrical magazine 16 and moves the tooth 109 onto the head of the selected punch 106.

Finally the ram is activated so as to press on said selector element 109 which in turn pushes the selected punch 10 towards the metal sheet to be machined below.

It should be noted that when a magazine 16 is equipped with just one punch, in this case positioned centrally inside it, the action of the selector element 109 becomes superfluous.

This type of use may be required in order to perform a number of consecutive steps in complex punching operations at a single point on the metal sheet; for example, it may be necessary to execute a cross-shaped through profile: for this purpose a single punch 106 with an elongated rectangular profile and a corresponding female die 108 can be used.

A first punching operation is performed to create one arm of the cross, then the magazines 16 and 17 are turned by a predetermined angle and a second punching operation is performed in such a way as to intersect with the first and thus create the required cross-shaped profile.

The angular rotation of said cylindrical magazines 16 and 17 determines the angle at which the arms of the cross-shaped profile intersect.

It should also be noted that both drive shafts 22 and 23 are provided with the possibility of adjusting the axial clearance. With reference to one of them, for example 22, the same applying to the other, the aforesaid adjustment is performed by turning the second ring nut 40, which, when tightened or loosened on the thread 39, produces axial movement of the shaft 22 pressing against the box-shaped support 38 in which it is retained, thereby adjusting its position.

Both the shaft 22 and the shaft 23 rotate inside their respective liners 34 and 48, which in turn are fixed respectively to the abutment 27 projecting from the monobloc constituting the operating turret 4 of the punching machine 1 and to the flange 41, integral with the base frame 2.

The first ring nut 36 and the third ring nut 50, when tightened on their respective threads 35 and 49 formed on said liners 34 and 48, fasten against the abutment 27 and the flange 41 the assemblies consisting of the drive shafts 22 and 23 and the respective motor assemblies 20 and 21, the opening 31 and the cylindrical body 45, thus securing everything respectively to the turret 4 and the base frame 2.

The Belleville washer 60, interposed between the flange 41 and the enlarged head 48a of the second cylindrical liner 48, is able to absorb the strokes of the ram in such a way that they do not damage the cylindrical element 13 during the machining operation, and to perform precise vertical adjustment of the cylindrical element 13 itself.

It has been observed in practice that the described invention achieves the proposed objectives.

The invention described above is open to modifications and variants, all of which fall within the scope of protection as defined by the following claims.

Furthermore, all details are replaceable with others that are technically equivalent and any materials, forms and dimensions may be used according to requirements. For example, the terms upper, lower, horizontal, vertical, above and below are used merely to describe relative orientations. Other relatively equivalent orientations will also be within the scope of the claims.

1. A punching machine comprising a base frame which defines an upper horizontal work table for working metal sheets and bars, an operating turret positioned above said work table and housing a punching ram, a first support member for at least one male punch holder driven rotationally by a respective first motor assembly and supported on said turret in vertical alignment below said punching ram, a second support member for a female die holder inserted in said work table in vertical alignment with said first support member and driven rotationally by a respective second motor assembly synchronised with said first motor assembly, at least one element for selection and contact with at least one male punch interposed between said ram and said male punch holder driven rotationally by a respective third motor assembly, wherein said male punch holder and female die holder can be driven by respective drive arrangements with synchronous rotational movement around a common vertical axis relative to said first support member and said second support member.

2. A punching machine as defined in claim 1, wherein said first and second support members consist of cylindrical elements, with a number of housings for housing a number of male punch holders and female die holders.

3. A punching machine as defined in claim 2, wherein said male punch holder and said female die holder each consist of a cylindrical magazine for housing respectively a predefined number of male punches and a corresponding number of female dies.

4. A punching machine as defined in claim 1, claim 2, or claim 3, wherein said first support member and said second support member contain corresponding axial housings for insertion, in a rotationally free manner, of cylindrical magazines for male punches and female dies.

5. A punching machine as defined in any one of claims 1 to 4, wherein a device for transmission of said rotational movement is provided between said male punch holder and female die holder and the said respective rotational drive arrangement.

6. A punching machine as defined in any one of claims 1 to 5, wherein cylindrical magazines for housing male punches and female dies are provided perimetrically with a device for mechanical coupling with said rotational drive arrangement and/or with said rotational movement transmission device.

7. A punching machine as defined in any one of claims 1 to 6, wherein said arrangement for rotationally driving said male punch holder and female die holder comprises:
respective motor/gear motor assemblies fixed respectively to said operating turret and to said base frame and mutually synchronised,
a first and a second drive shaft each projecting respectively from said motor/gear motor assemblies,
a corresponding gear member engaged with the free ends of said first and second drive shaft and engageable with said mechanical coupling device and/or with said rotational movement transmission device,
and a support and guide arrangement for said first and second drive shafts.

8. A punching machine as defined in claim 7, wherein said first and second drive shafts are supported vertically, coaxially and with their respective free ends concurrent.

9. A punching machine as defined in claim 7 or claim 8, wherein said motor assemblies are controlled by a member for angular indexing of rotation.

10. A punching machine as defined in any one of claims 7, 8 or 9, wherein said support and guide arrangement for said first drive shaft comprises:
an abutment projecting from said operating turret of said punching machine provided with axial cavity, in which said first drive shaft can be accommodated in a coaxial traversing manner,
a device for axial retention of said first drive shaft in said abutment, and
a device for the rotationally free passage of the lower of said first drive shaft through said first support member of at least one male punch holder.

11. A punching machine as defined in any one of claims 7 to 10, wherein, at least between said first drive shaft and said support and guide arrangement, there is provided a device for controlling the axial clearance of said first drive shaft.

12. A punching machine as defined in any one of the preceding claims when dependent upon both claim 2 and claim 10, wherein said device for the rotationally free passage of said first drive shaft comprises:
a through opening formed centrally in a first of said cylindrical elements with a number of housings, and
an anti-friction member interposed between said lower end of said first drive shaft and said opening, located in the respective housings formed therein.

13. A punching machine as defined in claim 10 or claim 12, wherein said device for axial retention of said first drive shaft in said abutment comprises:
a rotationally fixed cylindrical liner, inside which said first drive shaft can be accommodated in a rotationally free manner and which is interposed between this and the internal cavity of said abutment and between this and said opening,
a thread formed peripherically on said lining upstream of said abutment,
a first ring nut resting against said abutment fitted coaxially onto said lining and screwable onto said thread for the axial movement of said lining pushing against said abutment, and
a lower edge projecting radially from said lining, for axial retention of said lining inside said opening pressing against the tightening of said first ring nut.

14. A punching machine as defined in claim 11 and claim 13, wherein said device for controlling the axial clearance of said first drive shaft comprises:
a box-shaped support mounted integrally on the head of said lining vertically traversable by the upper end of said first drive shaft,
a second perimetral thread formed on said first drive shaft substantially in the position of said box-shaped support, and
a second ring nut that can be retained in said box-shaped support and screwable onto said second thread for the axial movement of said first drive shaft relative to said lining.

15. A punching machine as defined in any one of the preceding claims when dependent upon any one of claims 7, 8 or 9, wherein said support and guide arrangement for said second drive shaft comprises:
a coupling flange projecting from said base frame of said punching machine and provided with an axial cavity, in which said second drive shaft can be accommodated in a coaxial traversing manner,
a device for axial retention of said second drive shaft in said flange, and
a device for the rotationally free passage of said second drive shaft through said second support member of at least one female die holder.

16. A punching machine as defined in claim 15, wherein at least between said second drive shaft and said support and guide arrangement, there is provided a device for controlling the axial clearance of said second drive shaft.

17. A punching machine as defined in claim 2 and either claim 15 or claim 16, wherein said means for the rotationally free passage of said upper end of said second drive shaft comprises:
a cylindrical body with axial cavity engaged centrally in said cylindrical elements with a number of housings, and
an anti-friction member interposed between said upper end of said second drive shaft and said cylindrical body, located in said housings formed therein.

18. A punching machine as defined in claims 15 and 17, wherein said device for axially retaining said second drive shaft in said coupling flange comprises:
a second rotationally fixed cylindrical liner, inside which said second drive shaft can be accommodated in a rotationally free manner and which is interposed between this and said internal cavity of said coupling flange and between this and said cylindrical body,
a third thread formed peripherically on said second liner downstream of said coupling flange, and
a third ring nut resting on said coupling flange fitted coaxially onto said second liner and screwable onto said third thread for axial movement of said second liner pressing against said coupling flange.

19. A punching machine as defined in any one of the preceding claims when dependent upon claim 16, wherein said device for controlling the axial clearance of said second drive shaft comprises:
a second box-shaped support mounted integrally at the base of said second liner and vertically transversable by the lower end of said second drive shaft,
a fourth perimetral thread formed on said second drive shaft substantially in the position of said second box-shaped support, and
a fourth ring nut which can be retained in said second box-shaped support and is screwable onto said fourth thread for the axial movement of said second drive shaft relative to said coupling flange.

20. A punching machine as defined in any one of the preceding claims when dependent upon claim 3 and claim 7, wherein said device for transmission of rotational movement consists of ring gears that perimetrically enclose said cylindrical magazines and are engageable with said gear member.

21. A punching machine as defined in any one of the preceding claims when dependent upon claims 7 and 20, wherein said device for transmission of rotational movement consists of corresponding perimetrically toothed idle rollers which are interposable between said gear member and said ring gears.

22. A punching machine as defined in any one of the preceding claims when dependent upon claim 7, wherein said gear member consists of respective sprockets engaged in a rotationally fixed manner to the concurrent ends of the first and the second drive shafts.

23. A punching machine as defined in any one of the preceding claims when dependent upon claims 2 and 15, wherein an elastic shock-absorbing arrangement is interposed at least between the enlarged head of said second cylindrical liner and said flange.

24. A punching machine as defined in claim 23, wherein said elastic shock-absorbing arrangement consists of at least one Belleville washer.

25. A punching machine substantially as hereinbefore described with reference to the drawings.
